(19) United States
(12) Patent Application Publication
(10) Pub. No.: US 2012/0309470 A1
(43) Pub. Date: Dec. 6, 2012

(54) DUAL-AXIS HINGE DEVICE FOR A PORTABLE APPARATUS AND CAM UNIT THEREOF

(75) Inventors: Jeong-Seok PARK, Gyeonggi-do (KR); Kwang-Su SEO, Gyeonggi-do (KR)

(73) Assignee: Samsung Electronics Co., LTD., Gyeonggi-do (KR)

(21) Appl. No.: 13/486,327

(22) Filed: Jun. 1, 2012

(30) Foreign Application Priority Data
Jun. 3, 2011 (KR) 10-2011-0053725

(51) Int. Cl. E05D 3/12; E05F 1/08; H04W 88/00

(52) U.S. Cl. 455/575.3; 16/366; 16/303

(57) ABSTRACT

A dual-axis hinge device in a portable apparatus is provided, in which a first hinge unit has a first driving cam for rotating upon a first hinge axis along with rotation of a second housing, and a second hinge unit having a second driving cam adapted to be engaged with the first driving cam rotating upon a second hinge axis parallel to the first hinge axis, while reciprocating along the second hinge axis.

### CLAIM OF PRIORITY

This application claims priority under 35 U.S.C. §119(a) to a Korean Patent Application filed in the Korean Intellectual Property Office on Jun. 3, 2011 and assigned Serial No. 10-2011-0053725, the contents of which are incorporated herein by reference.

### BACKGROUND OF THE INVENTION

1. Field of the Invention

The present invention relates to a portable apparatus such as a cellular phone, a laptop computer, a smart phone, a Personal Digital Assistant (PDA), a Web hard drive, a game player, etc., and more particularly, to a dual-axis hinge device for providing two parallel hinge axes and a cam unit thereof

2. Description of the Related Art

In general, portable apparatus can be classified into a bar type, a folder type, and a sliding type. Recently, a wearable type has also been introduced. Wearable-type portable apparatus include a glass type and a wrist type.

Among above portable apparatus, a folder-type portable apparatus must include a hinge device that rotatably connects two housings to each other. The hinge device may be adapted to provide one or two hinge axes. That is, a single-axis or double-axis hinge device may be used in the portable apparatus.

The hinge device is typically provided with a cam unit (i.e. a driving cam and a driven cam) and an elastic member. Owing to an elastic member in the cam unit and a cam motion between the driving cam and the driven cam, the hinge device provides a stopping angle to a rotating housing and facilitates opening and closing of the portable apparatus. Facilitating opening and closing of the portable apparatus requires a force to consistently maintain a closed portable apparatus closed, an opening force to maintain the portable apparatus open at a predetermined first angle or greater, and a stopping force to maintain the portable apparatus at a predetermined second angle.

A dual-axis hinge device for a portable apparatus is disclosed in Korea Registered Utility Model Gazette No. 20-0439610 (Patent Application No. 20-2007-0002620).

The disclosed hinge-type cover opening and closing device has a drawback in that it suffers from a deviation in opening a folder. Even a slight deviation on the screwed portion of a gear makes the opening and closing operation unstable. As a result, product reliability is decreased. Moreover, since the gear is fabricated by die casting, the manufacturing cost is increased.

Accordingly, there exists a need for an improved dual-axis hinge device that can stabilize an opening and closing operation and reduce the fabrication cost.

### SUMMARY OF THE INVENTION

An aspect of embodiments of the present invention is to address at least the problems and/or disadvantages and to provide at least the advantages described below. Accordingly, an aspect of embodiments of the present invention is to provide a dual-axis hinge device for enabling stable opening and closing operations in a portable apparatus and a cam unit thereof

Another aspect of embodiments of the present invention is to provide a dual-axis hinge device having a two-stage cam structure for increasing reliability and a cam unit thereof

A further aspect of embodiments of the present invention is to provide a dual-axis hinge device for contributing to a reduction in manufacturing cost and a cam unit thereof

In accordance with an embodiment of the present invention, there is provided, in a portable apparatus having a first housing, a second housing, and a dual-axis hinge device for rotatably connecting the second housing to the first housing, the dual-axis hinge device in which a first hinge unit having a first driving cam for rotating upon a first hinge axis along with the rotation of a second housing, and a second hinge unit having a second driving cam adapted to be engaged with the first driving cam and rotating upon a second hinge axis parallel to the first hinge axis, while reciprocating along the second hinge axis.

In accordance with an embodiment of the present invention, there is provided a cam unit in a dual-axis hinge device for providing first and second parallel hinge axes in a portable apparatus, in which a first driving cam rotates upon a first hinge axis, and a second driving cam is adapted to be engaged with the first driving cam and, along with rotation of the first driving cam, rotates upon a second hinge axis parallel to the first hinge axis, while moving along the second hinge axis.

### BRIEF DESCRIPTION OF THE DRAWINGS

The above features and advantages of certain embodiments of the present invention will be more apparent from the following detailed description taken in conjunction with the accompanying drawings, in which:

FIG. 1 is a perspective view of a portable apparatus having a dual-axis hinge device in a closed state according to the present invention;

FIG. 2 is a perspective view of the portable apparatus having the dual-axis hinge device in an about 180-degree open state according to the present invention;

FIG. 3 is a front view of the dual-axis hinge device installed in first and second frames in the closed state according to the present invention;

FIG. 4 is a front view of the dual-axis hinge device installed in the first and second frames in the about 180-degree open state according to the present invention;

FIG. 5 is a front view illustrating the interior structure of the dual-axis hinge device with a part of hinge housing removed therefrom in accordance with the present invention;

FIG. 6 is a perspective view of first and second driving cams in the dual-axis hinge device according to the present invention;

FIG. 7 is a perspective view of first and second driven cams in the dual-axis hinge device according to the present invention;

FIG. 8 is a perspective view of the dual-axis hinge device during an operation in progress according to the present invention;

FIG. 9 is a perspective view of a first guide bushing in the dual-axis hinge device according to the present invention; and

FIG. 10 is a perspective view of a second guide bushing in the dual-axis hinge device according to the present invention.

Throughout the drawings, the same drawing reference numerals will be understood to refer to the same elements, features and structures.

### DETAILED DESCRIPTION

Reference will now be made in detail to the preferred embodiments of the present invention with reference to the accompanying drawings. Like reference numerals denote the same components throughout the specification and the drawings.

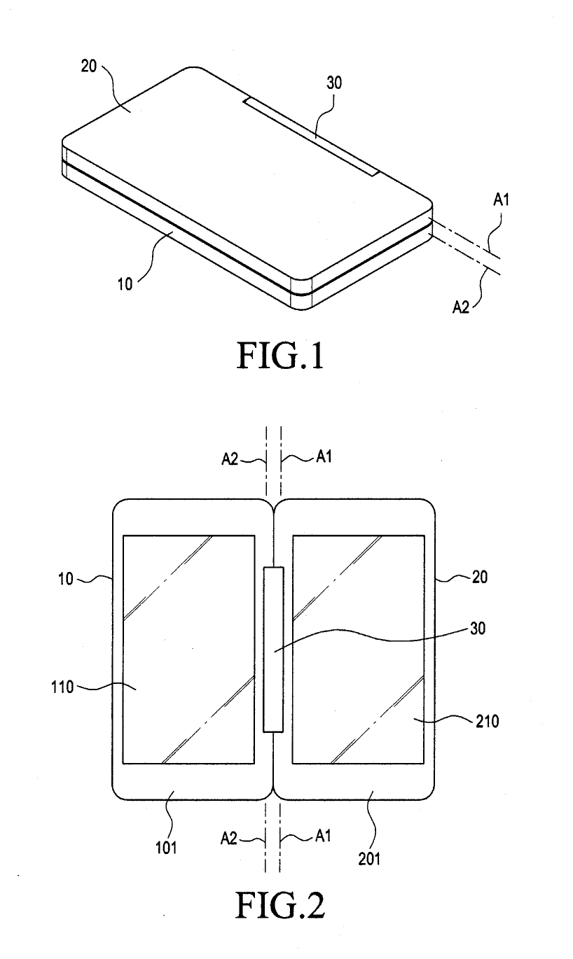

FIGS. 1 and 2 illustrate a portable apparatus having a dual-axis hinge device 30 according to the present invention. Referring to FIGS. 1 and 2, the portable apparatus includes a first housing 10, a second housing 20, and the dual-axis hinge device 30 for coupling the second housing 20 to the first housing 10 in such a manner that the second housing 20 can rotate with respect to the first housing 10 upon first and second hinge axes A1 and A2. The first hinge housing 10 includes a data input unit or data Input/Output (I/O) unit 110 on its inner surface 101 and the second housing 20 includes a data output unit or data I/O unit 210 on its inner surface 201. The data I/O unit 110 or 210 may be a touch screen. Alternatively, the data input unit 110 may be a keypad and the data output unit 20 may be a display.

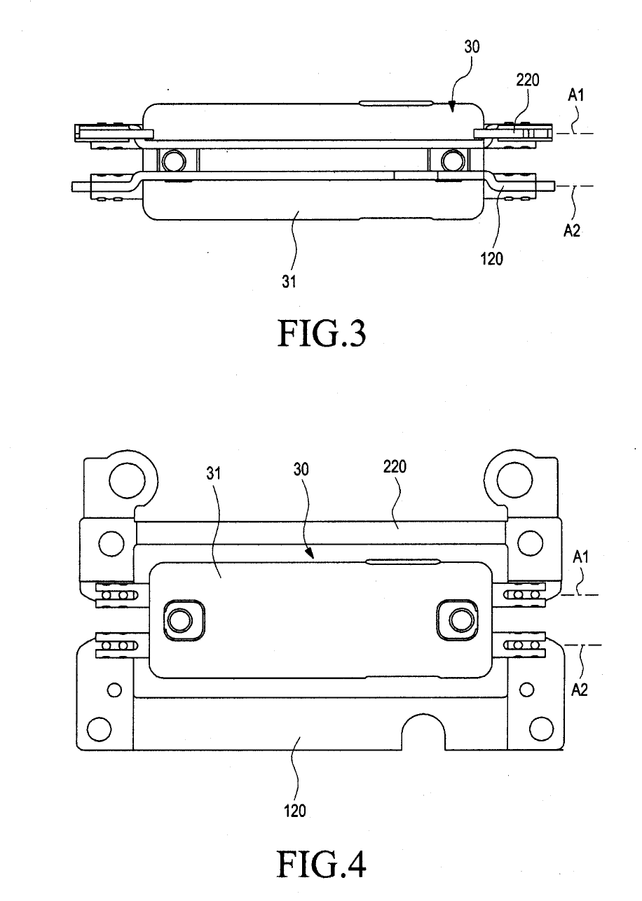

Referring to FIGS. 1, 3 and 4, the dual-axis hinge device 30 is shown in FIGS. 1 and 2 as having a hinge housing 31 only. While not shown, first and second driving cams, first and second driven cams, first and second guide bushings, first and second hinge springs, first and second hinge shafts, and a Flexible Printed Circuit Board (FPCB) guide, which will be described later with reference to other figures, are accommodated in the hinge housing 31 of the dual-axis hinge device 30.

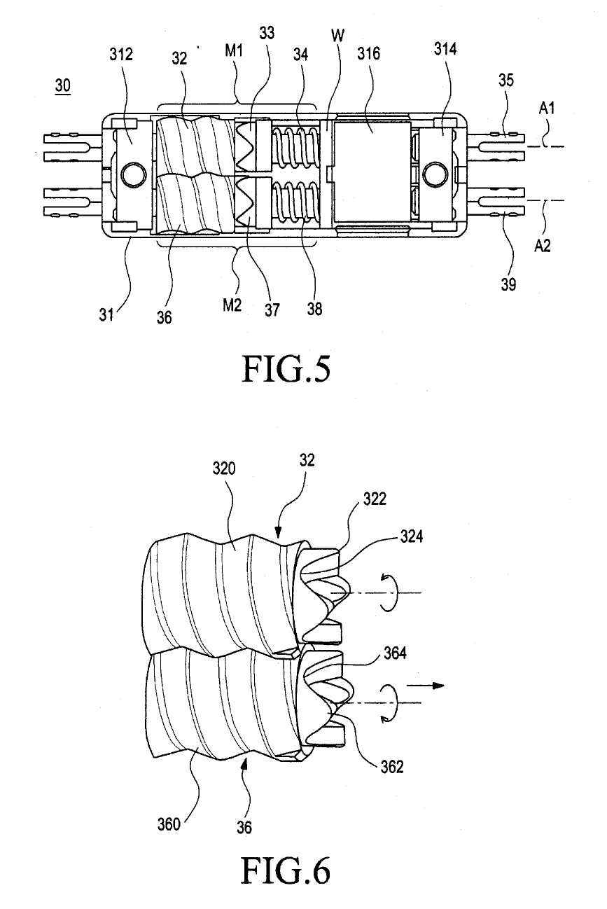

With reference to FIGS. 5 and 6, in the dual-axis hinge device 30, a first hinge shaft 35 is exposed outward from the hinge housing 31, for engaging with a first frame mounted in the first housing 10, and a second hinge shaft 39 is exposed outward from the hinge housing 31, for engaging with a second frame mounted in the second housing 10. Fastening grooves for engaging the first and second hinge shafts 35 and 39 with the first and second frames are not shown.

Hereinafter, the structure of the dual-axis hinge device 30 according to the present invention will be described.

Referring to FIGS. 5 and 6, the dual-axis hinge device 30 includes a first hinge unit M1, a second hinge unit M2, first and second bushings 312, 314, and an FPCB guide 316. The first and second guide bushings 312 and 314 are disposed at both ends of the hinge housing 31, for supporting the first and second hinge shafts 35 and 39 rotatably. The first and second hinge units M1 and M2 are disposed next to the first guide bushing 312, and the FPCB guide 316 is disposed next to the second guide bushing 314 between the first and second guide bushings 312 and 314. A separation wall W is interposed between the first and second hinge units M1 and M2 and the FPCB guide 316. The separation wall supports the first and second hinge units M1 and M2 and positions the FPCB guide 316. The first hinge unit M1 provides the first hinge axis A1, and the second hinge unit M2 provides the second hinge axis A2 parallel to the first hinge axis A1. The first hinge unit M1 is mounted inside the hinge housing 31, and the second hinge unit M2 is also mounted inside the hinge housing 31, in parallel to the first hinge unit M1.

In operation, the first hinge unit M1 rotates about the first hinge axis A1 along with rotation of the second housing 20. Along with the rotation of the first hinge unit M1, the second hinge unit M2 rotates about the second hinge axis A2 parallel to the first hinge axis A1, while making a linear reciprocal motion along the second hinge axis A2, as shown in FIG. 8. For these operations, the first hinge unit M1 includes a first driving cam 32, and the second hinge unit M2 includes a second driving cam 36 that is engaged with the first driving cam 32. With the first hinge shaft 35 forcedly fit into the first driving cam 32, the first driving cam 32 rotates along with rotation of the first hinge shaft 35. With the second hinge shaft 39 inserted into the second driving cam 36, the second driving cam 36 rotates along with rotation of the first driving cam 32, while linearly moving along the second hinge shaft 39.

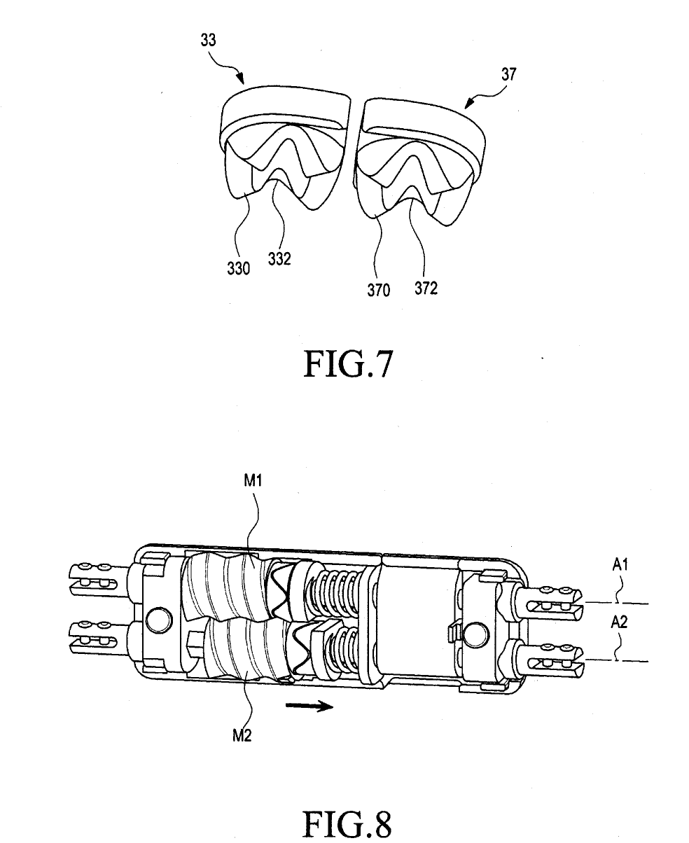

Referring to FIGS. 6 and 7, the first driving cam 32 is brought into close contact with a first driven cam 33, face to face, by means of a first elastic member 34 illustrated in FIG. 5. Along with rotation of the first driving cam 32, the first driven cam 33 moves along the first hinge axis A1 while rotating. The first driven cam 33 is formed of synthetic resin, for example, plastic to thereby contribute to cost reduction.

Referring to FIGS. 6 and 7, the first driven cam 33 has one or more cam protrusions 330 and one or more cam recesses 332, for creating a cam motion with cam protrusions 322 and cam recesses 324 of the first driving cam 32 along with rotation of the first driving cam 32. When the cam protrusions 330 of the first driven cam 33 are fully inserted into the cam recesses 324 of the first driving cam 32, the first elastic member 34 is fully pulled. When the cam protrusions 330 are removed from the cam recesses 324, the first elastic member 34 is compressed. The first elastic member 34 is a compressed coil spring.

The second driving cam 36 is brought into close contact with a second driven cam 37, face to face, by means of a second elastic member 38 illustrated in FIG. 5. Along with rotation and linear movement of the second driving cam 36, the second driven cam 37 moves along the second hinge axis A2, while making a cam motion with the second driving cam 36. The second driven cam 37 is formed of synthetic resin, for example, plastic by molding to thereby contribute to cost reduction.

The second driven cam 37 has one or more cam protrusions 370 and one or more cam recesses 372, for creating a cam motion with cam protrusions 362 and cam recesses 364 of the second driving cam 36 along with rotation of the second driving cam 36. When the cam protrusions 370 of the second driven cam 37 are fully inserted into the cam recesses 364 of the second driving cam 36, the second elastic member 38 is fully pulled. When the cam protrusions 370 are removed from the cam recesses 364, the second elastic member 38 is compressed. The second elastic member 38 is a compressed coil spring.

For a cam motion, the dual-axis hinge device 30 includes the first and second driving cams 32 and 36 as well as the first and second driven cams 33 and 37, as stated before. These cams 32, 36, 33 and 37 collectively form a cam unit. A first screwed portion 320 is formed on an outer circumferential surface of the first driving cam 32, and a second screwed portion 360 is formed on an outer circumferential surface of the second driving cam 36 for engaging with the first screwed portion 320. That is, when the first driving cam 32 rotates upon the first hinge axis A1 with the first and second screwed portions 320 and 360 in engagement, the second driving cam 36 rotates upon the second hinge axis A2 parallel to the first hinge axis A1, while moving along the second hinge axis A2. When the cam protrusions of driving cams 32 and 36 are interlocked with the cam protrusions of driven cams 33 and 37, a stopping force is provided to the second housing. When the cam protrusions of driving cams 32 and 36 are removed from the interlocked position from the cam protrusions of driven cams 33 and 37, a closing force or an opening force is provided to the second housing.

Referring to FIG. 8, when the first hinge shaft 35 rotates, the first and second driving cams 32 and 36 rotate simultaneously. At the same time, the second driving cam 36 moves linearly in an arrowed direction. Then, the second elastic member 38 is compressed. The cam unit of the first and second hinge units M1 and M2 repeats the above operation according to an opening or closing operation of the housing in the portable apparatus.

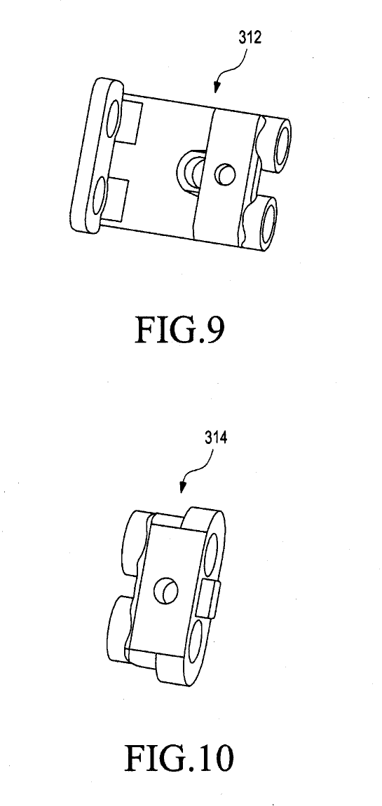

FIG. 9 is a perspective view of the first guide bushing 312 in the dual-axis hinge device 30, and FIG. 10 is a perspective view of the second guide bushing 314 in the dual-axis hinge device 30. As shown, the first and second guide bushings 312 and 314 function to support the first and second hinge shafts 35 and 39 illustrated in FIG. 5 in such a manner that the first and second hinge shafts 35 and 39 are rotatable within the hinge housing 31. To this end, the first and second hinge shafts 35 and 39 have support openings for allowing the first and second hinge shafts 35 and 39 to be inserted through them.

It should apparent to those skilled in the art that the dual-axis hinge device according to the present invention contributes to cost reduction for the portable apparatus and increases reliability with opening and closing operations of the portable apparatus.

While the present invention has been particularly shown and described with reference to embodiments thereof, it will be understood by those of ordinary skill in the art that various changes in form and details may be made therein without departing from the spirit and scope of the present invention as defined by the following claims

What is claimed is:

1. In a portable terminal having a first housing, a second housing, and a dual-axis hinge device for rotatably coupling the second housing to the first housing, the dual-axis hinge device comprising:
a first hinge unit having a first driving cam for rotating about a first hinge axis along with rotation of the second housing; and
a second hinge unit having a second driving cam adapted to be engaged with the first driving cam, for along with rotation of the first driving cam, rotating about a second hinge axis parallel to the first hinge axis, while reciprocating along the second hinge axis.

2. The dual-axis hinge device of claim 1, wherein the first driving cam closely contacts a first driven cam supported by a first elastic member and reciprocates along with the first hinge axis while making a cam motion.

3. The dual-axis hinge device of claim 1, wherein the second driving cam closely contacts a second driven cam supported by a second elastic member and reciprocates along with the second hinge axis while making a cam motion.

4. The dual-axis hinge device of claim 2, wherein the first driving cam includes a first screwed portion on an outer circumferential surface of the first driving cam.

5. The dual-axis hinge device of claim 3, wherein the second driving cam includes a second screwed portion on an outer circumferential surface of the second driving cam.

6. The dual-axis hinge device of claim 1, further comprising a first hinge shaft coupled to the first driving cam, so that the first driving cam rotates together with the first hinge shaft.

7. The dual-axis hinge device of claim 1, further comprising a second hinge shaft coupled to the second driving cam, so that the second driving cam is rotatable along with the second hinge shaft.

8. The dual-axis hinge device of claim 6, further comprising first and second guide bushings are mounted to both ends of the first and second hinge units.

9. The dual-axis hinge device of claim 8, further comprising a Flexible Printed Circuit Board (FPCB) guide between the first and second hinge units and the second guide bushing, for electrically coupling the first and second housings.

10. The dual-axis hinge device of claim 1, wherein the first driving cam further includes at least one first cam protrusion and at least one first cam recess on one surface thereof, and the second driving cam further includes at least one second cam protrusion and at least one second cam recess on one surface thereof

11. The cam unit of claim 10, wherein the at least one first cam protrusion and the at least one first cam recess of the first driving cam interlocks with the at least one second cam protrusion and the at least one second cam recess of the second driving cam for closing.

12. The cam unit of claim 11, wherein the at least one first cam protrusion and the at least one first cam recess of the first driving cam separates from the at least one second cam protrusion and the at least one second cam recess of the second driving cam for opening.

13. A cam unit in a dual-axis hinge device for providing first and second parallel hinge axes in a portable apparatus, the cam unit comprising:
a first driving cam for rotating upon a first hinge axis; and
a second driving cam, adapted to be engaged with the first driving cam, and for rotating upon a second hinge axis parallel to the first hinge axis while moving along the second hinge axis.

14. The cam unit of claim 13, wherein the first driving cam includes a first screwed portion on an outer circumferential surface of the first driving cam, and the second driving cam includes a second screwed portion on an outer circumferential surface of the second driving cam for engaging with the first screwed portion.

15. The cam unit of claim 14, wherein the first driving cam further includes at least one first cam protrusion and at least one first cam recess on one surface thereof, and the second driving cam further includes at least one second cam protrusion and at least one second cam recess on one surface thereof

16. The cam unit of claim 15, wherein the at least one first cam protrusion and the at least one first cam recess of the first driving cam interlocks with the at least one second cam protrusion and the at least one second cam recess of the second driving cam for closing.

17. The cam unit of claim 15, wherein the at least one first cam protrusion and the at least one first cam recess of the first driving cam separates from the at least one second cam protrusion and the at least one second cam recess of the second driving cam for opening.

18. The cam unit of claim of claim 13, wherein the first driving cam closely contacts a first driven cam supported by a first elastic member and reciprocates along with the first hinge axis while making a cam motion, and wherein the second driving cam closely contacts a second driven cam supported by a second elastic member and reciprocates along with the second hinge axis while making a cam motion.
